(19) United States
(12) Patent Application Publication
(10) Pub. No.: US 2012/0287117 A1
(43) Pub. Date: Nov. 15, 2012

(54) FOUR-COLOR 3D LCD DEVICE

(75) Inventors: Michael F. Weber, Shoreview, MN (US); Timothy J. Nevitt, Red Wing, MN (US); Terry L. Smith, Roseville, MN (US)

(73) Assignee: 3M Innovative Properties Company

(21) Appl. No.: 13/106,936

(22) Filed: May 13, 2011

(51) Int. Cl. G06T 15/00; G02B 27/22

(52) U.S. Cl. 345/419; 359/464

(57) ABSTRACT

3D stereoscopic viewing enabled by the use of an LCD panel, dynamic backlight, and glasses. The system utilizes an LCD panel with an LED backlight having a 4-color red-green-blue-yellow pixel array and wavelength selective glasses to isolate each channel by color. The system is based on alternating left and right image frames on an LCD panel. One of the frames is illuminated by the red-green-blue LEDs, and the other frame is shown in gray scale and illuminated by the yellow LEDs. The viewer wears glasses where the left lens or filter passes only the spectrum of light used for the left channel of data, and the right lens or filter passes only the spectrum of light used for the right channel of data.

### BACKGROUND

There are currently two types of widely used three dimensional (3D) displays that can use passive eyewear for wide viewing angle 3D displays. These displays are either polarization based (different images shown in orthogonal polarizations and viewed separately by the left and right eyes) or wavelength based (different images shown with non-overlapping colored spectra and viewed separately by the left and right eyes). Both types of displays are now being used extensively in the movie cinema market segment. Applications to the television (TV) market have been hindered for both approaches by the following technical issues.

### Polarization Based Systems

In these systems, a first liquid crystal display (LCD) TV system creates alternate images in left and right hand circularly polarized light on a pixel row by row basis. There is a 50% loss of resolution with this micro-retarder approach: every other line on the TV is an alternate polarization, meaning each image uses only half of the pixels. In addition, the micro-retarder sheet adds significant cost to the system.

An alternative LCD TV system utilizes an active macro-retarder, which consists of a second LCD panel with no pixels and covering the entire screen. This second panel alternatively rotates the polarization of light exiting from the first full resolution panel from one state to the other, for example from horizontal to vertical so it can be discriminated by left eye and right eye polarized lenses. The active macro-retarder adds both cost and substantial weight to the system.

### Wavelength Selective Systems

The 3-color anaglyph systems have suffered from a lack of good wavelength selective glasses, and the color filters on the TV have overlapping spectra, leading to crosstalk. Much improved color filters for wavelength selective glasses can be supplied by low cost polymeric multilayer optical film (MOF) technology but this approach, such as red images for one eye and cyan (blue+green) images for the other eye, have limited appeal due to the way in which human vision system processes separated left eye/right eye color imagery.

The newer 6 color system of Infitec, Inc., as described in U.S. Patent Application Publication No. 2010/0066813 A1, which was adapted to theater systems by Dolby Laboratories, Inc., requires very precise wavelength selection for each image and for the filter on each eye. This precision requires substantially collimated light sources and precision filters on the sources. This light filtering leads to substantial losses of light from the sources and thus a lower TV power efficiency. For the typical cinema system, there is only one source of light and it can be collimated in the image projection system. For LCD TVs there are many sources distributed across the screen or around the edges. To first collimate, filter, and then randomize the distribution of all of these light sources for a large TV requires much more space in the TV backlight than is typically preferred by TV set makers. The resulting LCD TV is rather bulky: either very thick, or with a very wide bezel around the edges. The color filter eyewear also produces substantial glare to the viewers' eyes unless used in a very dark room. The glare is acceptable in a darkened cinema space, but not always in a person's home. The 6 color 3D system has such narrow pass and block bands that absorbers cannot be used to efficiently block the reflected light from one color band while simultaneously transmitting the color of adjacent pass bands.

For the above reasons, the first LCD 3D TVs have employed the active shutter glass approach in which LCD shutters, akin to welder's active goggles, are alternately opened and closed for the left and right eyes in sync with alternate left eye and right eye images that are displayed on the LCD panel. This system works for any high speed display, not just LCDs. The cost of shutter glasses, as well as the need to provide electrical power to them, have been disadvantages for these systems.

Thus there is still a need in the LCD industry for a simple 3D system that provides good color with full resolution images that can be implemented with low loss and within about the same size footprint as current LCD TV systems.

### SUMMARY

A 3D stereoscopic viewing system, consistent with the present invention, includes an LCD panel, a backlight for providing light to the LCD panel, and a controller for synchronizing the backlight with left and right frames of content. The backlight includes a first set of light sources having three colors and a second set of light sources having one color in a predominantly non-overlapping range of the visible spectrum compared with the first set. The system uses glasses to be worn by a viewer. The glasses have a first lens for filtering spectra of the first set of light sources and a second lens for filtering spectra of the second set of light sources, wherein each lens substantially blocks the wavelengths of light that are transmitted by the other lens. Therefore, the viewer's left and right eyes are provided with alternating left and right frames of the content to provide a 3D viewing experience.

### BRIEF DESCRIPTION OF THE DRAWINGS

The accompanying drawings are incorporated in and constitute a part of this specification and, together with the description, explain the advantages and principles of the invention. In the drawings,

FIG. 1 is a schematic diagram of a 4-color 3D LCD system;

FIG. 2 is a graph of a first spectra for the 3D system;

FIG. 3 is a graph of a second spectra for the 3D system;

FIG. 4 is a graph of a third spectra for the 3D system;

FIG. 5 is a graph of a fourth spectra for the 3D system;

FIG. 6 is a graph of the spectra for a trim filter;

FIG. 7 is a graph of the spectra for an alternative filter;

FIG. 8 is a graph of the spectra for a first glare reduction filter;

FIG. 9 is a graph of the spectra for a second glare reduction filter;

FIG. 10 is a graph of the spectra for a third glare reduction filter;

FIG. 11 is a graph of the color filter spectra of TV pixels along with the emission spectra from its white phosphor LED light sources;

FIG. 12 is a graph of the transmission of yellow light in the green or red pixel filters;

FIG. 13 is a graph of the transmission of yellow light presented by both green and red pixels;

FIG. 14 is a graph illustrating a modification of the red pixel filter;

FIG. 15 is a graph of the transmission of yellow light through the modified (shifted) red pixel filters; and

FIG. 16 is graph of the spectra of a yellow passband filter using two narrow blocking bands.

### DETAILED DESCRIPTION

### Overview

Embodiments of the present invention include the application of the 4-color anaglyph 3D approach to a TV or other display system which has relatively narrow band light sources in combination with potentially low cost, high precision polymeric interference filter eyewear. Compared to the 6-color system, which requires a total of five very narrow spectral blocking bands and five very narrow passbands for the pair of left and right eye lenses, the 4-color system requires only one narrow blocking band and one narrow passband for the pair of left and right eye lenses. The choice of the 4-color anaglyph approach, in combination with a TV backlight that utilizes narrow band emitting light sources, provides for a simplified, more efficient, full resolution 3D LCD display system with low crosstalk and high color gamut. We have found that narrow band 1-D and 3-D quantum well light-emitting devices can be chosen with four different emission colors across the visible spectrum such that their emission spectra have minimal spectral overlap so as to enable a 3D system with acceptably low crosstalk with the need for little or no trimming of their spectra. Examples of a 4-color anaglyph are provided in PCT Published Applications Publication Nos. WO2008/916110943, WO2008/916150967, and WO2008/916220960.

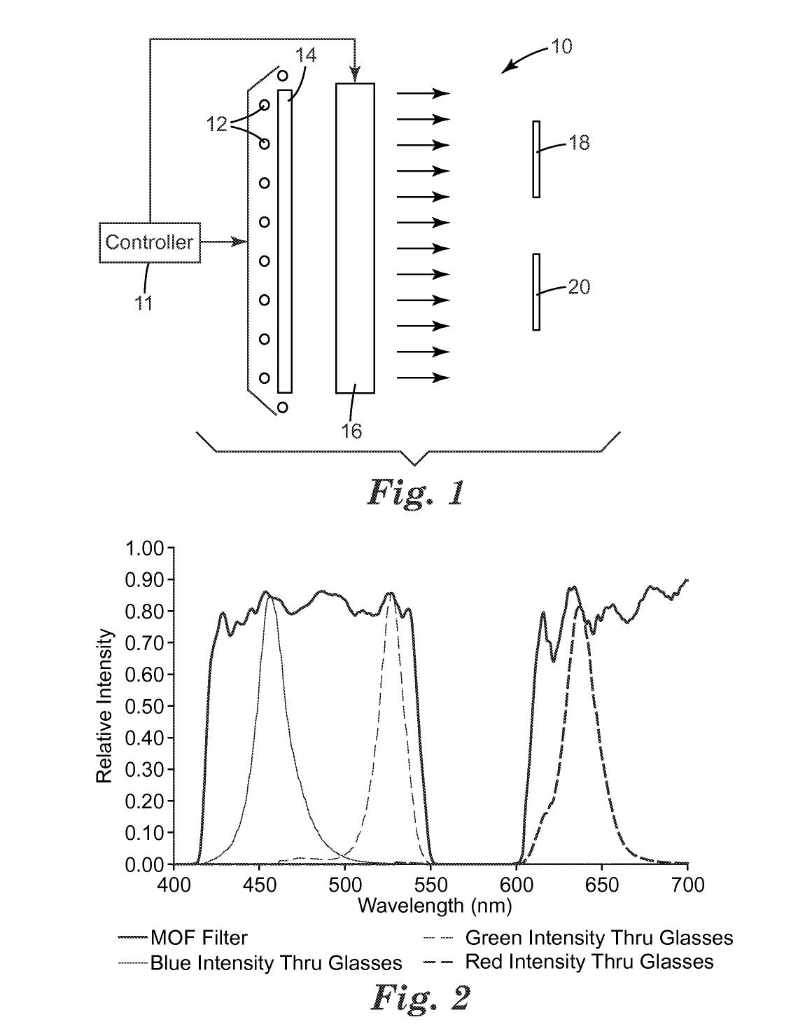

FIG. 1 is a schematic diagram of the applicable components of an LCD TV and glasses for a 4-color 3D LCD system 10. System 10 includes a controller 11, light sources 12, a backlight cavity 14, an LCD panel 16, a right eye lens filter 18, and a left eye lens filter 20. Controller 11 provides left and right image frames, either full frames or partial frames, to LCD panel 16 and synchronizes the images with light sources 12 having four colors with substantially non-overlapping spectra such as red-green-blue-yellow. One of the images is shown in color with the red-green-blue (RGB) light sources, and the other images are shown in gray scale with the yellow light, or other appropriate narrow band light sources. The controller alternates the left and right images, color and gray scale. A viewer wears glasses having color filters 18 and 20 to filter the left and right images and provide the viewer with a 3D viewing experience.

Various wavelengths ranges can be chosen for the gray scale image, with three other appropriate colors chosen for the color image. For example, a yellow or orange in the range of 540 to 630 nm, or a cyan in the range of 450 to 540 nm can be used for the gray scale image. For the former, an amber LED with peak spectral content near 595 nm can be used or a II-VI yellow emitting device with a peak spectral content near 570 nm can be used. Those skilled in the art may provide device peak wavelengths and bandwidths which provide different optimization between the LED emission and the optical glasses filter spectra. The II-VI yellow emitting devices are more efficient than the current amber LEDs made from III-phosphide compounds, and the choice of yellow provides more separation from the red than does an amber source.

LCD panel 16 can be implemented with an LCD panel capable of showing alternating left and right eye images with RGB, RGB-Y (yellow), or RGB-white pixels, although other color sets can also be used. Standard 3-color (RGB) LCD TV panels can be used in this system because the green and red pixel color filters transmit substantial amounts of yellow light. Backlight cavity 14 can be edge lit or direct lit from light sources 12 and can include a hollow (air) guide or a solid light guide.

Light sources 12 can be implemented with narrowband II-VI optically pumped one dimensional quantum well emitters (BGYRed) or with standard light emitting diodes (LEDs) such as Blue, Cyan, Amber, and Red, or Blue, Green, Amber, and Red. Crosstalk will be increased when using standard green LEDs. If the crosstalk is unacceptable, the LED spectra can be narrowed using the trim filters described below.

The 1-D quantum well emitters made from II-VI semiconductors are described in U.S. Pat. No. 7,737,831 and are an adapted LED comprising an electrically pumped shortwave LED and a re-emitting semiconductor construction. The II-VI light sources are constructed of CdMgZnSe alloys, and the emission spectra typically have full width at half maximum (FWHM) values of about 15 nm to 20 nm for the red, green and yellow emitters. This is to be compared to a green GaInN LED which has a FWHM value of about 30 nm to 35 nm. In one example, the measured values of the FWHM for a 520 nm (center wavelength) green GaInN LED was 33 nm compared to a FWHM of 17 nm for a 535 nm green II-VI emitter, when compared at similar intensities and temperatures.

It should be noted that the high power III-V LEDs (e.g., GaInN) currently use quantum wells to achieve high efficiency. In the long wavelength III-phosphides (e.g., amber, orange, red LEDs) the quantum well spectra are narrow like that for the II-VI emitters. In the short wavelength III-nitrides LED material systems, the emission peaks are wider. This feature is thought to be due to materials issues related to the GaInN system. Indium incorporation is accompanied by segregation, leading to compositional inhomogeneity and associated bandgap broadening, complicated by the fact that GaInN grown in the conventional orientation is piezoelectric, so strain due to the compositional inhomogeneity causes the local bandgap to fluctuate further, resulting in more broadening. If the emission broadening effects in GaInN LEDs can be reduced then they can be used for the low crosstalk systems described here without the need for trimming (filtering) their output spectra.

Examples of short-wavelength LEDs for implementing the II-VI light sources are also described in U.S. Pat. No. 7,402,831, which is incorporated herein by reference as if fully set forth.

Alternatively, quantum dot (three dimensional quantum well emitter) phosphors can be used as light sources, if they have relatively narrow wavelength emission ranges, even though not as narrow as the II-VI 1-D quantum well devices. Alternatively, standard GaInN LEDs can be utilized by trimming (narrowing) their spectra with absorbing (no angle dependence) dye filters, multilayer narrow band interference reflection/transmission filters, or by choosing LED colors that are further separated in wavelength space. The approach of wider color separation of the exemplary green and yellow LEDs by choosing, for example, cyan and amber in a Blue, Cyan, Amber and Red system results in a somewhat lower color gamut, but can still be acceptable. Using deeper blue and deeper red LEDs can help compensate the loss of color gamut, but the photopic efficiency of the system then decreases.

The transmission spectra of interference filters will shift with angle of incidence, so for precision trimming of spectra with those filters the light emitted by a broadband source is preferably first collimated by the appropriate optical devices such as lenses and/or shaped mirrors. The optional trim filters on one or more of the LEDs can be implemented with the following: dyed polymeric films; multilayer polymeric interference filters, II-VI absorber on the output side of 1-D II-VI quantum well layers; or LCD panel pixel color filters. Although the same approach could be used with a six color 3D system, the 4-color system allows for further separation of the individual color emitter spectra within the visible spectrum, resulting in wider acceptable red-green-blue-yellow (RGBY) emission bands. The wider emission bands then result in a reduced need for trimming and thus in more output from a given light source.

### 2D Performance of the Display

A 3D display system may also be required to display 2D images. In particular, for consumer TVs, the 2D mode will likely be required much more often than the 3D mode, at least for the near future. Therefore, it is preferable that the 2D mode of a 3D system be competitive with, or even better than, standard 2D displays. We have discovered that the narrow band II-VI light sources described here for 3D displays enable a 2D display that can have a higher color gamut and a higher energy efficiency than 2D LCD displays that are backlit with LEDs that are currently used for such displays. The green II-VI emitter, when pumped with a blue LED, has been demonstrated to be the highest efficiency of any LED based green light source as described in the paper Miller et.al. Proceedings of SPIE Volume 7617, paper #7617-72. Aside from the high efficiency of the II-VI 1D emitters themselves, their narrow band emission spectra in combination with the shape of the LCD pixel filters are reasons for the increased color gamut and efficiency of the LCD system as described below. Furthermore, since the II-VI 1D emitters are optically pumped and all can be made from the same II-VI semiconductor alloy system, multiple color constructions can be fabricated on the same chip which is pumped by a single shortwave LED. By this arrangement, all of the LEDs in the 2D system can use the same driver circuit, leading to lower system cost and higher efficiency. The same multi-color chip construction can also be used as the source for the color image in a 3D display system. In both systems, the combination of all colors on a single chip will reduce the color streaking which can occur on an edge lit system in which the color sources are necessarily spaced apart when using separate LEDs for each color. If color uniformity is a problem in a system with a solid backlight, a light spreading structure can be applied to the edge of the light guide as described in U.S. Patent Application Ser. No. 61/419,833, entitled “Illumination Assembly and Method of Forming Same,” and filed Dec. 4, 2010.

Techniques for making different color pixels or emitters on the same chip or die are described in PCT published applications WO 2008/109296 and WO 201074987, both of which are incorporated herein by reference as if fully set forth. Examples of other ways to combine colors on one chip are described in U.S. Pat. Nos. 7,084,436 and 6,212,213, both of which are incorporated herein by reference as if fully set forth. The following are examples of combinations of different color emitters on the same chip: RGB on a single die; RGB on a single die with independently addressable color regions for tuning; and RGBY on single die with the RGB combination and Y independently addressable or all colors independently addressable. These configurations are achieved on a single die by using a single short-wavelength pump LED to optically pump the conversion material. The pump LED die may be patterned into different, independently electrically driven regions, for separate control of the emission from different converter regions. The blue emission may be emission directly from the pump LED, or may be down-converted from a shorter wavelength such as a UV or violet emitting pump LED. The use of RGB or RGBY emitters on a single die can provide the following advantages: the emitter regions, being all pumped by the same type of pump LED, are driven by the same drive voltage with no need for separate drivers; color mixing is more effective than with separate emitters; and the green emitter achieved by down conversion is more efficient than standard GaInN green LEDs. These single die emitters can provide for a low cost, high quality LCD TV with a high color gamut.

### Efficiency and Color Gamut

In either 2D or 3D viewing mode, the interaction of the LCD pixel color filters with the light source spectra can have large effects on the efficiency and performance of the system. 4-color pixel LCD panels can be used for this 4-color 3D system. Examples are red, green, blue and yellow (RGB+Y), or red, green, blue and white (RGB+W) pixel sets. For the former, the yellow could be a pass band of yellow wavelengths, or a yellow edge filter that passes portions of green, yellow and red wavelengths. Such systems are now utilized for 2D TV panels. If such panels are utilized for the 3D system described herein, the RGB image can be presented with the RGB pixels or with the RGB+Y pixels, using only the RGB sources. The gray scale image in 3D mode can be presented using any or all of the 4 color pixels and only the gray scale, for example yellow, source.

Most LCD displays utilize only 3 color pixels, typically RGB, and it is advantageous to utilize the common LCD construction to make a lower cost 3D display. In 3D mode, the RGB image presentation can use the RGB pixels. The gray scale image, for example the yellow image in the preferred system, can be presented with one or more of the RGB pixels. Some options are discussed in the example below.

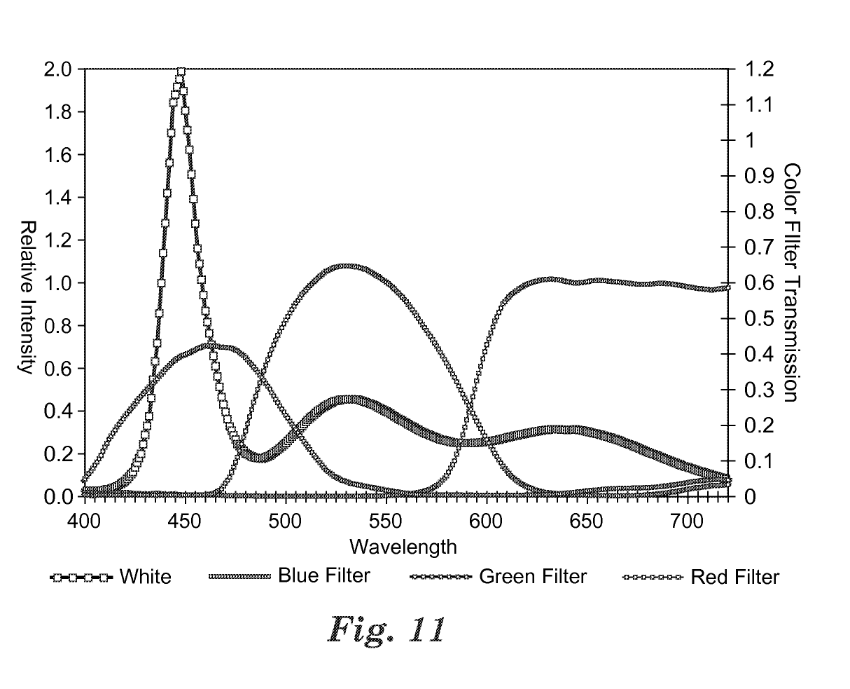

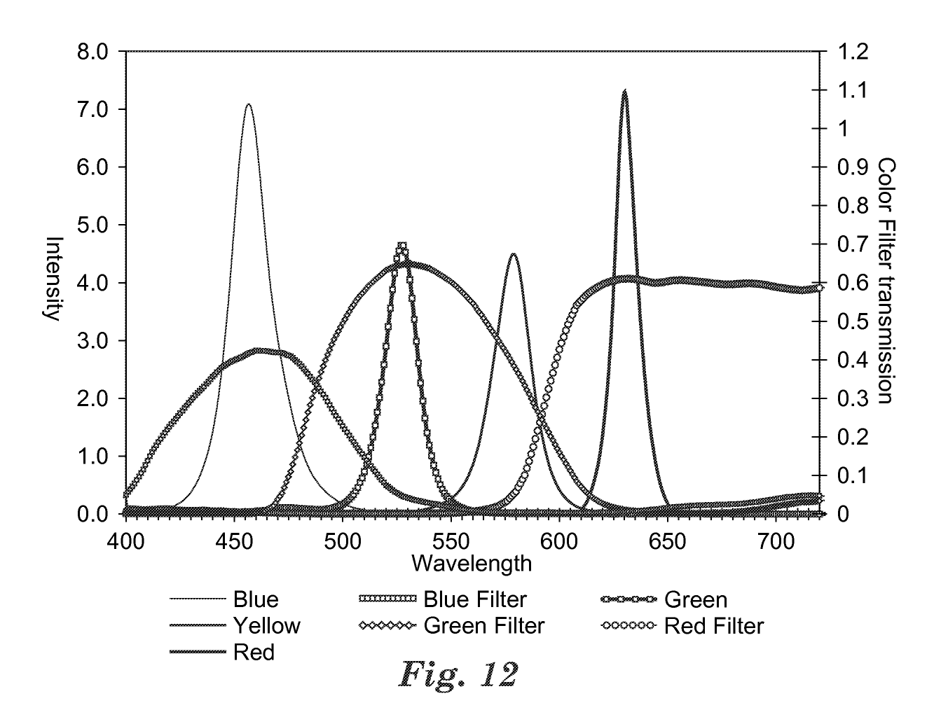

As an example, we have examined the color filters and light sources in a conventional LCD panel. The color filter spectra from the pixels in a Samsung TV (model # UN40C7000WF) and the emission spectrum from its white phosphor LED light sources are plotted in FIG. 11. Note that the phosphor LED is emitting light that is only slightly peaked in the green and in the red. Since these phosphors emit substantial amounts of light that falls in the wavelength region of low transmission of each of the blue, green and red filters, substantial amounts of light are absorbed. This absorption is needed to create an acceptable color gamut, but results in a decreased energy efficiency. For example, consider the same color filter spectra in combination with the narrowband II-VI emitter, plotted in FIG. 12. Each of the RGB light sources emit most of their light near the maximum transmission point of each color filter, thus enabling a higher transmission of viewable light. Also, the narrow spectrum of each of the RGB emission peaks enables a higher color gamut for the RBG image of the system, in the 2D mode as well as in the 3D mode.

In addition to 3D displays, a high efficiency 2D-only display can be made using the light sources and LCD panel designs discussed here.

### Yellow Intensity in 3D Mode

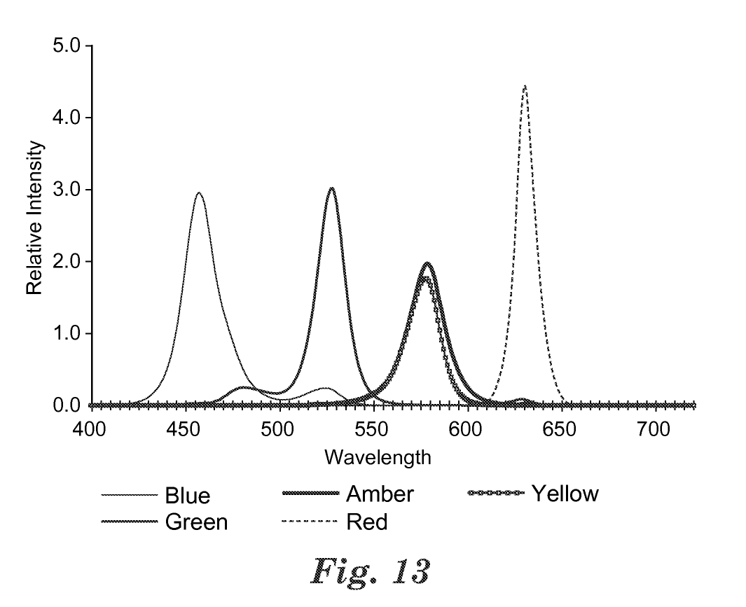

From FIG. 12 one can see that the transmission of the yellow light is not optimum in either of the green or red LCD pixel filters. Substantial amounts of yellow light can be transmitted through the green pixels and some yellow light can be transmitted through the red pixels. If the yellow image is presented by both the green and red pixels, a higher intensity of yellow is possible, as illustrated by the spectra in FIG. 13. The red filters are more effective if an amber LED is used instead of yellow II-VI emitters, but the green will then be slightly less effective.

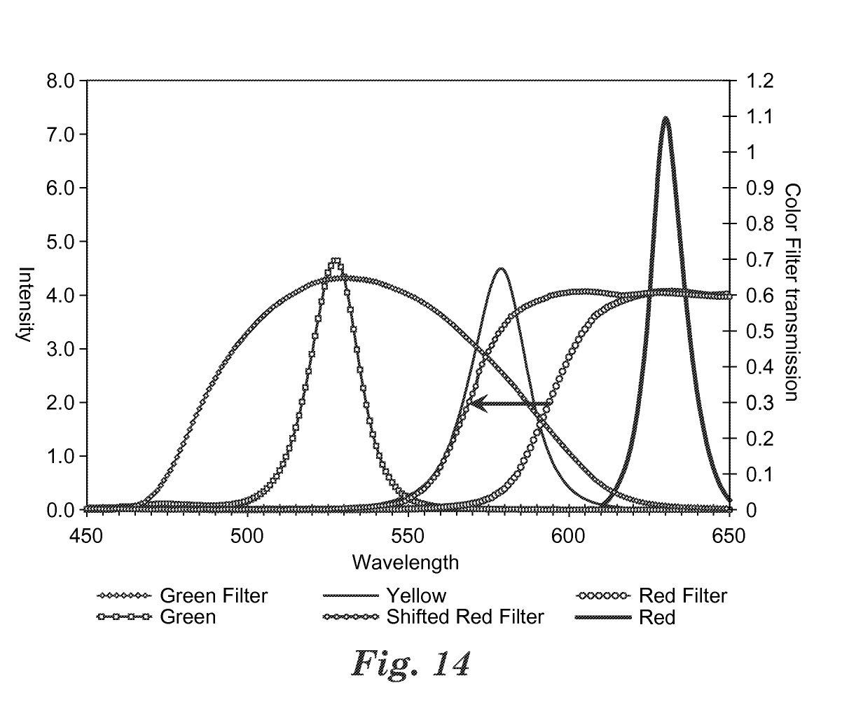

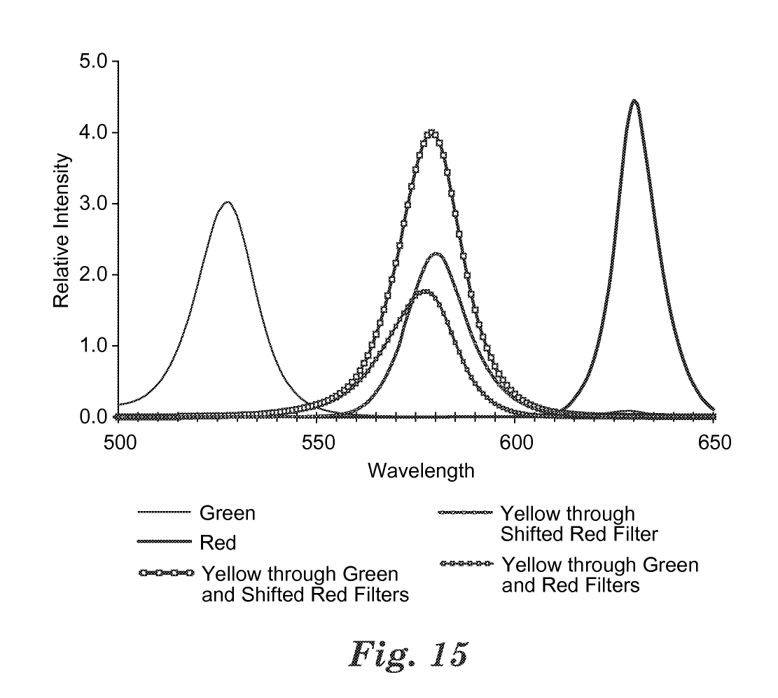

When narrowband emitters are utilized for both the green, red and yellow light sources, for example, sources with a FWHM of about 20 nm or less, there is another option to increase the transmission intensity of yellow light. The red filter on the display panel can be altered so as to transmit substantial amounts of yellow light and still transmit very little green light. Using narrow band emitters, the green emission long wave edge is now so far removed from the short wave edge of the red emission, the red color filter could be modified so that it also transmitted substantial amounts of the yellow light. Such a spectral modification is illustrated in FIG. 14 where the absorption edge of the red filter is shifted by about 25 nm to shorter wavelengths. In 3D mode both the green and the red pixels can then be used to provide the yellow image, almost doubling the intensity for the yellow image compared to a system that uses the standard red and green filters to present the yellow image (compare curves 1 and 2 in FIG. 15), without increasing the crosstalk with the green or red spectra. The high transmission enables the use of fewer or smaller yellow light sources, increasing the efficiency of the system. This arrangement can also reduce the crosstalk of the system because the higher transmission of yellow by the LCD panel permits a lower intensity of yellow light in the backlight.

A third transmission spectrum for yellow is shown in FIG. 15 for the case where the yellow light is transmitted only through the shifted red color filters. In this case the red pixel filters are being utilized as trim filters for the yellow light source. The resulting spectrum shows a much larger separation of the green and yellow image spectra. This would allow a display designer to change the green LED to longer wavelengths, for example from 525 nm to 540 nm, thus increasing the color gamut of the display in both 2D and 3D modes. Using the same blue pump LED, a 540 nm II-VI emitter will be slightly more efficient than a 527 nm emitter due to the increased separation of pump and emission wavelengths as well as due to an increase in photopic response at 540 nm. LCD displays designed only for 2D images would similarly benefit in efficiency and color gamut from this construction. Although the blue-shifted red pixel filter described above is not standard on current LCD displays, it does not require a change in pixel layout or in the display fabrication process. Multiple color pigment changes have been made before in the display industry, although 25 nm is a large spectral shift. The maximum useable shift in the red filter bandedge depends on the choice of peak wavelength for the green source. The bandedge of the red filter can be defined as the wavelength at half of the peak transmission, which is about 595 nm in the example shown here from the Samsung TV.

Shifts of the red filter bandedge of about only 5, 10, 15 or 20 nm to shorter wavelengths are also useful in increasing the efficiency of this system.

In 2D mode with an active backlight, the yellow LEDs could be turned on as needed to optimize the color rendition of various images.

The term yellow light is used to include narrow band sources with peak intensity at wavelengths in the range of about 565 nm to 600 nm. Narrowband is defined for all color sources as one exhibiting an FWHM of less than about 25 nm. The preferred FWHM is 20 nm or less. Exemplary II-VI sources exhibit FWHM values of 17 nm. Peak intensity and FWHM refer to values that would be measured near typical operating conditions in an LCD display.

### 3D Glasses

Filters 18 and 20 for the viewer glasses, including the various MOF filters described below, can be implemented with polymeric interference filters for left eye/right eye color discrimination. In particular, the spectra for the glasses can be designed using the approach of creating one or more infrared reflecting bands and tailoring the ratio of high index layer thickness to the thickness of a layer pair (the f-ratio) to create various higher order harmonics of narrow bandwidth and steep bandedges in the visible portion of the spectrum. An example of these types of filters and a process to make them is described in U.S. Pat. No. 7,138,173, which is incorporated herein by reference as if fully set forth. Filters 18 and 20 can include dyed color filter layers on the viewer side of eyewear film for glare reduction or for simplified interference filter construction.

In order to show both left eye and right eye images simultaneously, the colored light sources and the colored pixels on the LCD panel should both exhibit narrowband (substantially non-overlapping) spectra and a 4-color pixel panel is required. Current LCD panels have significant spectral overlap of the RGB(Y) pixels, meaning the left and right eye images must be shown alternatively in time. In this scheme there are four sets of spectra of importance to the proper construction of the 3D TV system, as explained below.

Spectra 1—High Brightness Full Color Image to the First Eye, which can be Termed the RGB Eye

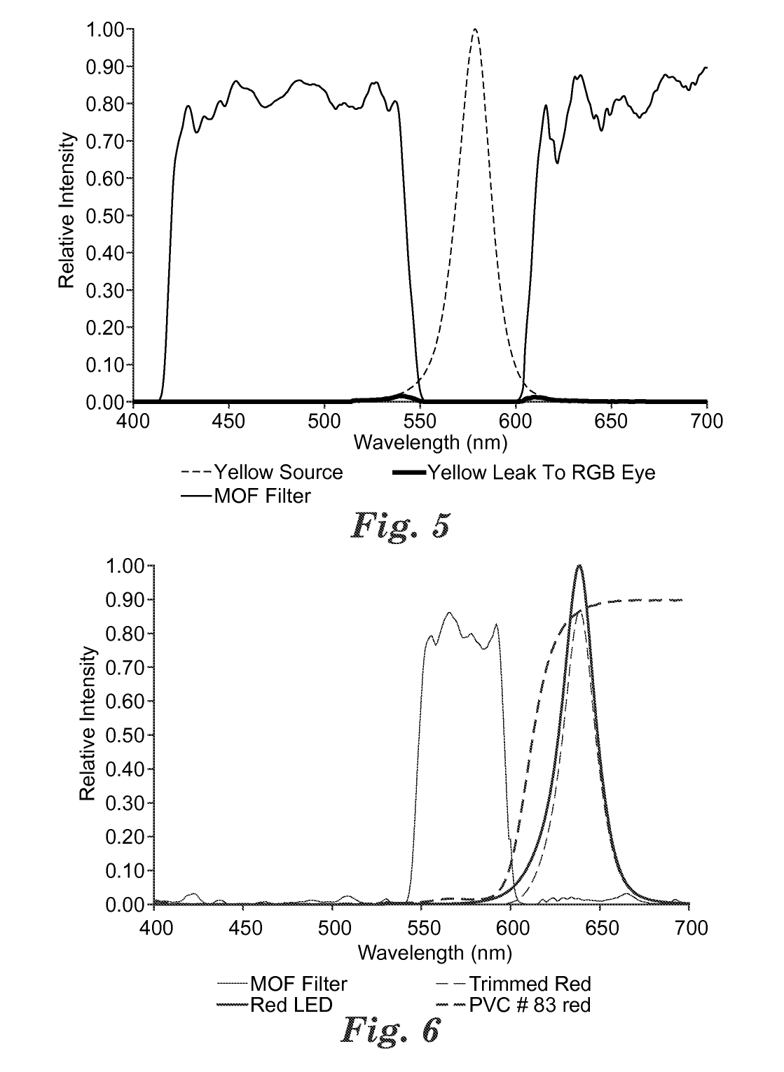

A color image, created by three colors which can be controlled by the RGB pixels of a standard LCD panel should be transmitted to the eye through a color lens that blocks a fourth color, the fourth color being used to create an image for the other eye, as illustrated by the spectra in FIG. 2. The sharp wavelength cutoff of the yellow blocking filter in this example, in conjunction with the narrow emission spectra of the chosen light sources, results in high transmission of all three of the RGB colors. The importance of the spectral width of this yellow blocking filter is discussed in conjunction with the blocking of yellow light (crosstalk) to the RGB eye (see FIG. 5).

Spectra 2—Low Leakage (Crosstalk) of the RGB Eye Image Light to the Second Eye, which will be Termed the Yellow Eye

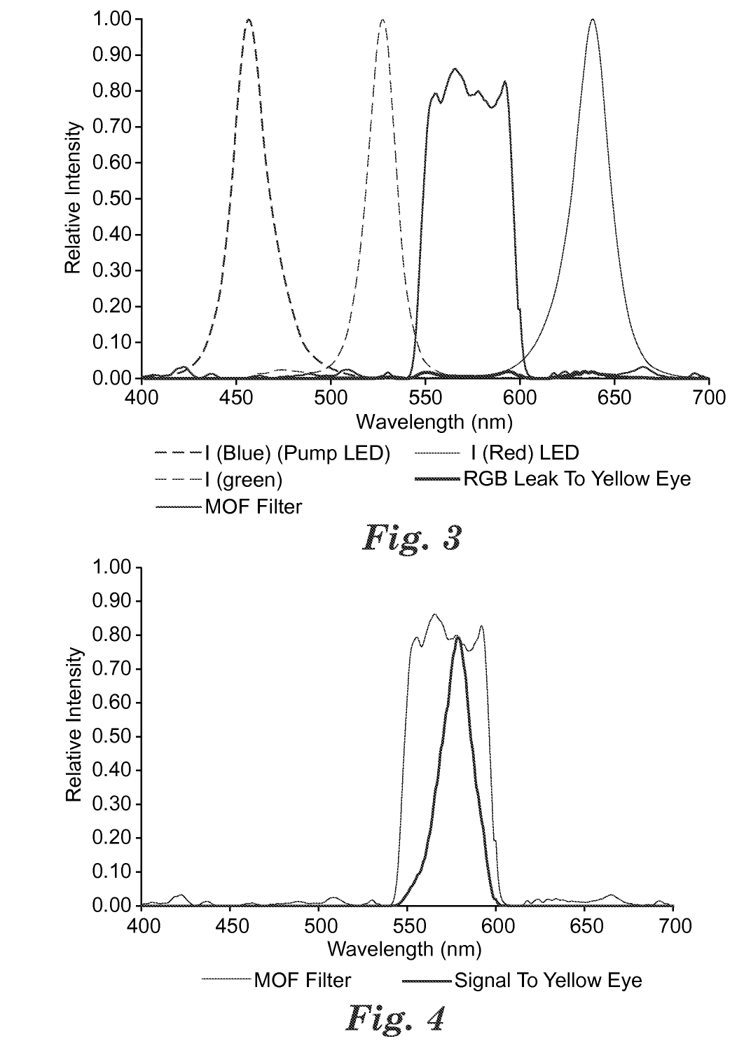

Blue, green and red light should be blocked from reaching the yellow eye by a second colored lens. A spectrum of a multilayer interference filter that can substantially achieve this is plotted in FIG. 3. The crosstalk leakage is given by the curve labeled RGB leak to yellow eye. The leak near 550 nm can be reduced by narrowing the bandpass filter width so that it blocks light up to, for example, 555 nm. As is shown in FIG. 4, such a change will not substantially impact the transmission of yellow light to the yellow eye. The leak near 600 nm can be reduced by two methods. It can be blocked by narrowing the bandpass width even more by moving the adjacent bandedge down to a lower wavelength such as, for example, 590 nm. Such a change will reduce the transmission of yellow light to the yellow eye as can be inferred from the spectra in FIG. 4. Alternatively, a red pass trim filter can be applied to each red LED to absorb the short wavelength tail on the red LED, as illustrated in FIG. 6. The light leakage of the yellow pass filter above 600 nm can be blocked by improvements in the design of the multilayer filter.

### Spectra 3—High Brightness Monotone Color Image to the Yellow Eye

The eye that views the gray scale image (yellow in this example) should be fitted with a lens that transmits most of the narrow band yellow light and blocks most of the light of the colored image. The transmission spectrum of such a bandpass filter is plotted in FIG. 4. Transmission should be maximized for the yellow light source. As discussed above with respect to crosstalk issues, moving the left bandedge to 555 nm will not substantially reduce the amount of yellow light. Moving the right bandedge to values below 600 nm will however reduce the intensity of yellow light substantially. Greater in-band transmission can be provided with improvements in the layer thickness profile of the optical film. The gray scale image can be formed by one or more sets of colored pixels commonly found on LCD TV display panels. Typically the yellow light can be transmitted by either the red or the green pixels, or both. Some LCD TVs use a yellow or a white pixel, which can also be used. The intensity of the yellow light source plotted in FIG. 4 should be scaled with the appropriate intensity level as should the intensities of the red, green and blue sources plotted in FIG. 2 be scaled so as to provide both the desired color balance and visually appealing 3D effect of the system as a whole.

The spectral width of the yellow (or gray scale) eye filter transmission band is limited by the separation of the green and red light source emission bands. The yellow transmission band may be made with some spectral overlap of the green or red sources, or both, in order to increase the amount of either the display or ambient lighting transmitted by the glasses. A low light transmission level in the gray scale lens can create an effect of a dark covering over one eye when viewing objects illuminated by ambient light. For viewing the 3D display, the proper intensity of the gray scale image should be maintained so as to prevent a retinal rivalry effect. Further, increasing the bandwidth of the yellow (or gray scale) filter transmission, even at the expense of some increase in crosstalk between the gray scale and the color imagery may increase the luminance into the gray scale eye, also reducing the retinal rivalry effect with acceptable left/right eye crosstalk.

To reduce the retinal rivalry effect, the luminance of the yellow (gray scale) channel can be adjusted with the drive power of the yellow (gray scale) LEDs, or by increasing the transmission of the gray scale image light by using, for example, higher transmission pixel filters for the gray scale light as discussed above.

Further it may be desirable to choose the left or the right eye to be the gray scale eye, based on a sampling of the population as to which eye would be preferable. It is also possible to add a switch to the display unit to provide a choice to the user as to which eye views the gray scale image. The user must then select glasses with the corresponding left/right eye filter arrangement.

### Spectra 4—Low Leakage (Crosstalk) of the Yellow Eye Image to the RGB Eye

Light from the yellow image should be blocked from reaching the RGB eye. This is accomplished with a narrow “bandstop” filter such as one with the spectra plotted in FIG. 5. This is the same filter spectra shown in FIG. 2 with respect to transmitting the light of the RGB image. The leakage, crosstalk, of yellow image light to the RGB eye is plotted with the curve labeled yellow leak to RGB eye. The leakage of the red tail of the yellow LED in FIG. 5 near 610 nm can be reduced by moving the RBE of the bandstop filter up to 610 nm. As can be inferred from FIG. 2, this can be accomplished without substantially reducing the intensity of light from the red LED. The crosstalk leak near 540 nm can be blocked by widening the bandstop spectra even further so as to block light from 540 nm to 610 nm. However, this widened spectrum will block some of the green light from the green LED, resulting in lower brightness of the display. Alternatively, the yellow or the green light sources can be chosen with a more widely separated wavelength gap between them. Such adjustments need to be made carefully, though, since they can affect the overall color gamut of the display and the overlap of the yellow and red light sources.

Overall, the intensity of the crosstalk is inherently low if one selects light sources with narrow band emission spectra. Lasers can be used, but they currently have high costs and low efficiencies. The narrow band emission spectra and high efficiencies of the optically pumped II-VI compound and longwave III-phosphide quantum well devices are preferred for this application. Trim filters for the shortwave side of the II-VI emitters can be fabricated in-situ on the II-VI wafer during the MBE (molecular beam epitaxy) process. The II-VI compounds are direct gap semiconductors and exhibit sharp absorption edges. The trim filter can be fabricated of a material similar to a given II-VI quantum well device, but with a slight higher bandgap so as to block the shorter wavelengths emitted by the device while transmitting the emitted light of longer wavelengths.

### LED Trim Filters

An example of a trim filter is illustrated in FIG. 6 for a red LED. A dyed PVC film (PVC #83) with measured spectra given by the curve labeled PVC #83 red can be positioned near or laminated to the output face of the LED. The calculated output of the trimmed LED is plotted with the curve labeled trimmed Red. Peak transmission of the source/filter combination is improved if lamination is used so as to eliminate air interfaces of the filter and the light source. Anti-reflection coatings are also useful in this regard. Dye based trim filters can also be used with the quantum well emitters. Inorganic absorbing filters can also be used for these light sources.

Although the two sets of images for left eye and right eye in the above examples are referred to above as the RGB image and the yellow image, there are alternative color sets that can be used such as those described in the published PCT applications identified above.

### Alternative Lens Filter

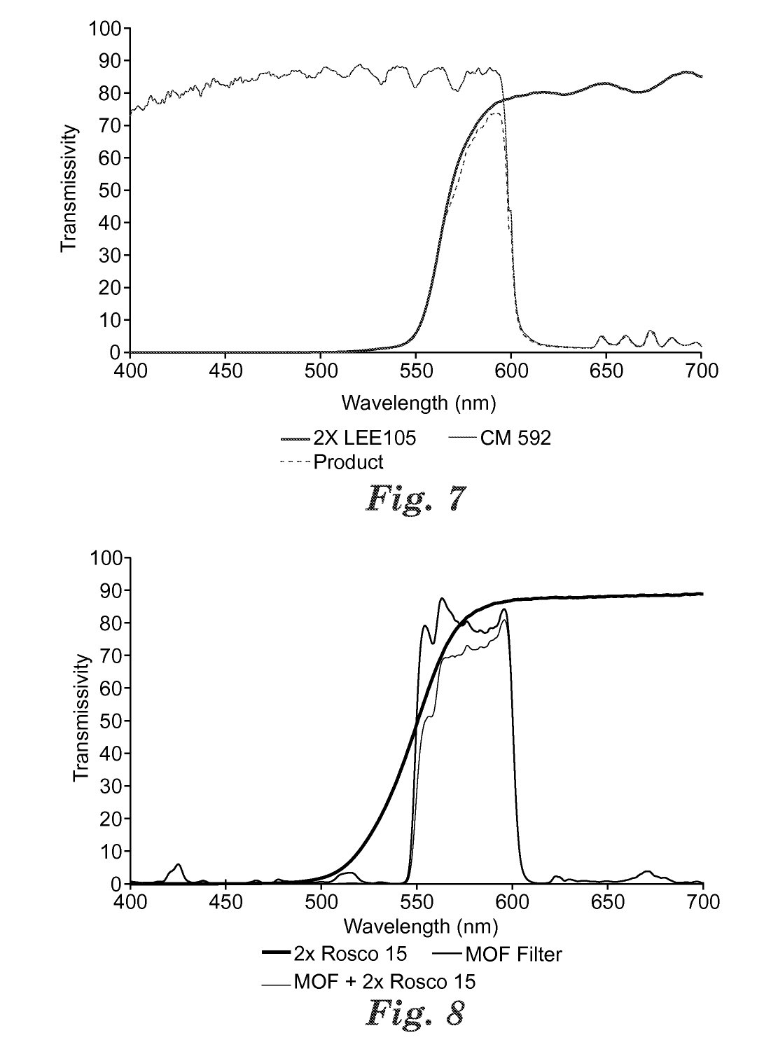

An alternative lens filter for the 3D system can include a lamination of a dyed film with an MOF. This dye/MOF film laminate can be made from a color mirror (CM) 590 or 592 film from 3M Company in combination with a dyed color film. The spectra of this laminate construction and the filters described above are shown in FIG. 7. In order to obtain a yellow pass filter, the laminate construction can include a film of CM 592 with an orange dyed film. An orange filter with the appropriate spectrum is manufactured by Lee Filters. Two layers of the Lee #105 orange film were laminated to CM 592. The spectra of this filter is plotted in FIG. 7. Note that one bandedge of the passband is formed by the MOF, the other bandedge being formed by the dye. In a variation of this construction, both bandedges of the passband can be formed by MOF constructions using two blocking bands that are separated so as to form a local passband. The MOF bandedges are sharper than those available from most dyes and can result in a higher transmission of the yellow source light without inducing more leakage of the green light. Such an MOF construction, using narrow stop bands, may not block light that is further removed in wavelength from the passband. A color dye that absorbs these more distant wavelengths, such as blue or cyan light, can be added to the MOF construction to block light at other wavelengths that are outside of the passband.

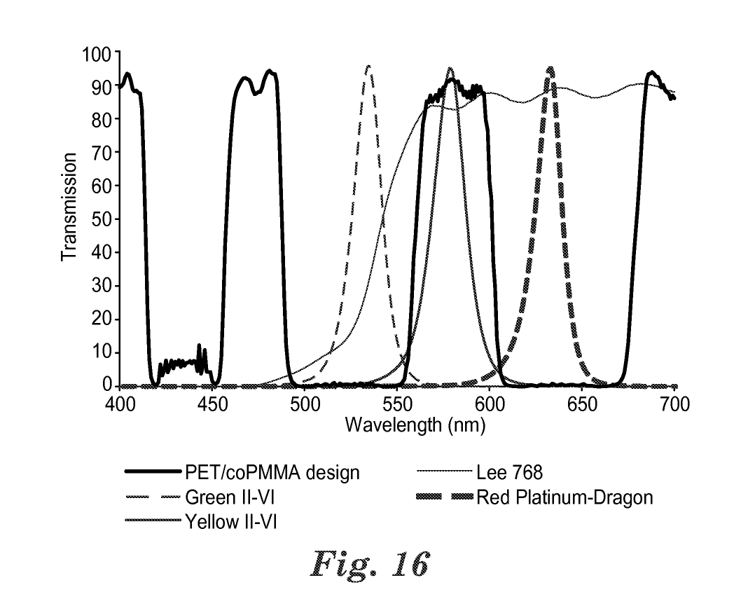

An example of a yellow passband filter constructed of two narrow blocking bands is illustrated by the spectra shown in FIG. 16. The emission spectra of narrow band green, yellow, and red II-VI emitters are also plotted in FIG. 16. The passband spectrum is formed between the two blocking bands, one centered near 525 nm and the other centered near 640 nm. Each of these bands is the second order harmonic reflection of an infrared reflecting band (not shown), centered near 1130 nm and 1260 nm respectively. This spectrum was designed using a quarterwave stack of 275 layers of oriented PET (polyethylene terephthalate) and coPMMA (a copolymer made from ethyl acrylate and methyl methacrylate monomers), assuming respective indices of 1.65 and 1.494 at 633 nm for the two polymers. The f-ratio was assumed to be 0.75 and 275 layers were used to create each IR reflection band.

Sharp bandedges are difficult to make with the first order band of a multilayer stack, the higher orders such as orders #4, 5, 6, . . . having much sharper bandedges. However the higher orders have much lower optical power, requiring a very large number of layers to get the required reflectivity. We have discovered that the second order band of a PET/coPMMA stack can be used to make sharp bandedges, which is thought to be due to the narrow intrinsic band width of a stack of PET/coPMMA which has a small index difference between layers (delta n=0.16).

As described above, this design does not block all of the blue light as needed, although the third order harmonic of the thicker IR stack does reflect light from about 416 nm to 456 nm. The rest of the blue light can be absorbed by a yellow filter such as, for example, a Lee filter #768. The single yellow blocking band for the other eye can be made from either one of these bands alone by an adjustment in the layer thickness values to move the bands to shorter or longer wavelengths respectively. Alternatively, the two bands could be overlapped to form a single reflection band to block yellow light.

An example is also given below which combines glare reduction with crosstalk reduction.

### Glare Reduction

As shown in FIG. 7, the CM 592 film only reflects red light and the orange dyed film absorbs substantially only blue and green light. Thus the dyed film in the laminate construction will not block any substantial amounts of MOF reflected light, no matter which film in the construction is facing the viewer. This construction however does create a useful yellow pass filter for the 3D system as described above and can be used in place of the interference bandpass filter described above.

The eyewear construction described above with respect to Spectra 1-4 will reflect both blue and green light as well as red light, which will increase the glare to the viewer's eyes unless used in a darkened room. To reduce this glare, absorbing films can be placed behind the reflective films on the viewer side to absorb substantial portions of the blue, green, and red light without blocking substantial amounts of yellow light. An example of a blue and green absorbing filter is shown in FIG. 8. The absorbing filter (2 layers of Rosco #15 dye filter) also blocks the residual leaks in the MOF spectrum (near 450 nm and 530 nm). As described above, the MOF filter could be simplified and reflect much less of the short wavelength light, the dye being used to absorb light of those wavelengths. The absorbing filter can be laminated to the MOF with an optically clear adhesive, and the total transmission is given by the curve labeled MOF+2× Rosco. Although the spectrum of the Rosco #15 films transmits some green light between 510 nm and 550 nm, this light will be much attenuated in the reflective mode with the MOF because the light must pass through the film again after it is reflected from the MOF. This will double the optical density of the absorbing filter with respect to the glare, greatly reducing the glare from the reflected green and blue light. Also note from FIG. 8 that the reduction of transmission of yellow light of 570 nm light by the addition of the absorbing filter, is less than about 10%. Yellow light of 590 nm is reduced by less than about 5%. An alternative to the Rosco #15 filter is the Lee #768 filter (Egg Yolk Yellow) manufactured by Lee Filters. The Lee #768 filter is preferred over the Rosco #15 filter in that the Lee #768 filter has higher transmission throughout most of the yellow spectrum compared with the Rosco #15 filter.

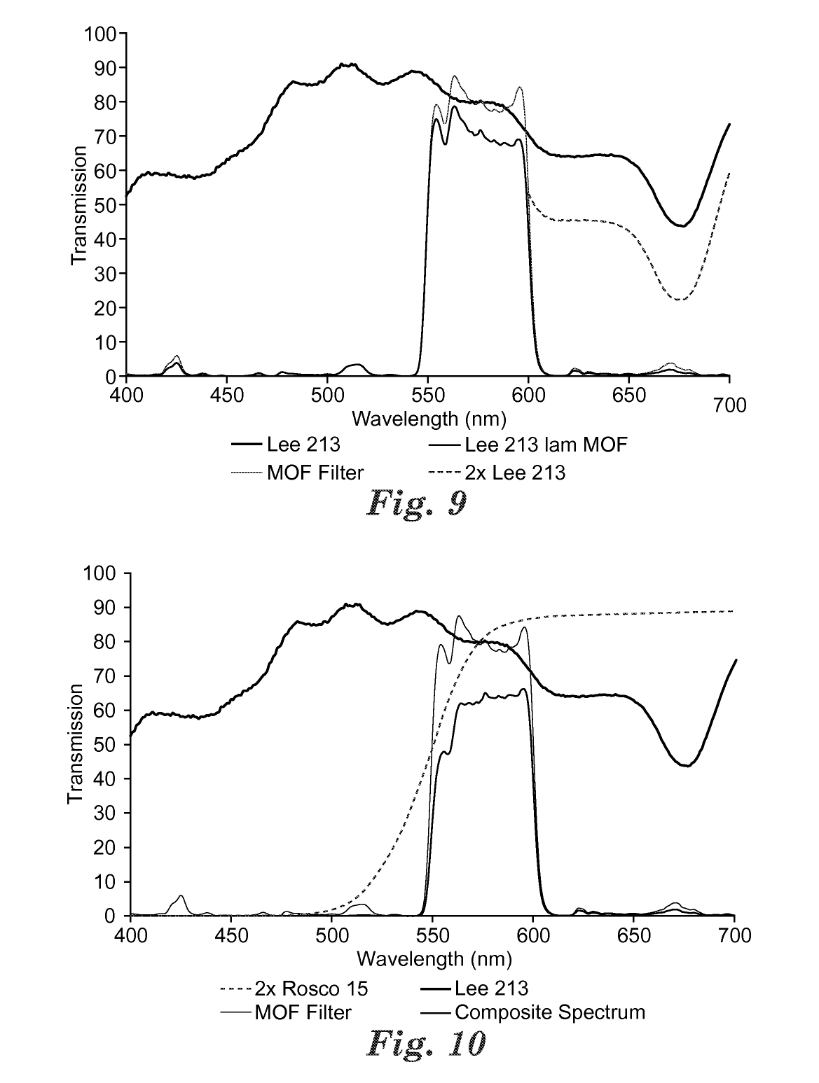

The eyewear of FIG. 8 will still reflect red light, which can also cause glare. It is well known that there are few dyes that absorb substantially all of the red light and transmit most of the yellow light. However, the same approach can be used again, i.e. a dye that partially absorbs red light while absorbing a lesser amount of yellow light can greatly reduce the glare from the reflected red light. An example is shown in FIG. 9. The absorbing filter is a Lee filter #213. In order to demonstrate the reduction of red reflectance via the double pass of the red light, the transmission of red light through a double layer of filter #213 (film laminated to itself) is also shown in FIG. 9 by the curve labeled 2× Lee 213. With the Lee 213 filter, about 50% of the red light that is reflected by the yellow pass filter would be absorbed. However, the addition of this filter reduces the yellow transmission only by about 10%. Increasing the red light absorption will further reduce the glare from reflected red light, but it will also decrease the in-band transmission of the yellow bandpass filter. A satisfactory compromise can be reached which balances the needs of brightness against the problem of glare from room lighting. In general, it is desirable that each glare reduction dye contribute only about a 10% loss or less of the desired transmitted light, or more generally that the combined absorption of all dyes desirably reduce the transmission of light at the peak wavelength of the desired transmitted light source by less than about 25%.

The dyes of both the Lee 213 and Lee 768 or the Rosco 15 filters can be combined into one film, or alternate dye combinations can be used to optimize and simplify this construction. The composite transmission of the MOF yellow bandpass, the orange and the green “anti-reflection” filters is plotted in FIG. 10. The total reduction in intensity of yellow light due to the addition of the absorbing dyes is less than about 20%.

In summary, dyed films useful for reducing glare are those that substantially reduce the amount of reflected light from a multilayer reflector in any of the blue, green, yellow or red wavelength ranges while transmitting substantial intensities of the desired color wavelengths. Although wavelength selective absorbers are preferred so as not to decrease the desired color transmission, a neutral gray absorber also can be used here. For example, a gray filter of about 70% transmission will reduce the glare producing reflections of a reflector by about 50% due to the double pass of reflected light through the absorbing layer, yet it will only reduce the transmission of the desired colors by only about 30%.

1. A 3D stereoscopic viewing system, comprising:
an LCD panel;
a backlight for providing light to the LCD panel, the backlight comprising:
a first set of light sources having three colors; and
a second set of light sources having a fourth color, wherein the first set of light sources emits light in a predominantly non-overlapping range of the visible spectrum than the second set of light sources;
a controller for synchronizing the backlight with left and right frames of content transmitted to the LCD panel; and
glasses to be worn by a viewer, the glasses having a first lens for filtering spectra of the first set of light sources and having a second lens for filtering spectra of the second set of light sources,
wherein each of the first and second lenses substantially blocks wavelengths of light that are transmitted by the other lens such that the viewer's left and right eyes are provided with alternating left and right frames of the content for a 3D viewing experience.

2. The system of claim 1, wherein the first and second light sources comprise quantum well emitters.

3. The system of claim 1, wherein the first and second light sources comprise II-VI 1-D quantum well emitters.

4. The system of claim 1, wherein the first and second light sources comprises LEDs.

5. The system of claim 2, further comprising a spectral filter to narrow the spectral emission band of one or more of the quantum well emitters.

6. The system of claim 3, further comprising a spectral filter to narrow the spectral emission band of one or more of the II-VI 1-D quantum well emitters.

7. The system of claim 4, further comprising a spectral filter to narrow the spectral emission band of one or more of the LEDs.

8. The system of claim 1, further comprising a glare reduction filter on a viewer side of the glasses.

9. A 3D stereoscopic viewing system, comprising:
an LCD panel;
a backlight for providing light to the LCD panel, the backlight comprising:
a first set of red, green, and blue light sources having, respectively, first ranges of red, green, and blue spectra; and
a second set of yellow light sources having, respectively, a second range of yellow spectra,
wherein the first ranges are different from the second ranges;
a controller for synchronizing the backlight with left and right frames of content transmitted to the LCD panel; and
glasses to be worn by a viewer, the glasses having a first lens for filtering the first ranges of red, green, and blue spectra and having a second lens for filtering the second ranges of the yellow spectra,
wherein each of the first and second lenses substantially blocks wavelengths of light that are transmitted by the other lens such that the viewer's left and right eyes are provided with alternating left and right frames of the content for a 3D viewing experience.

10. The system of claim 9, wherein the first and second light sources comprise quantum well emitters.

11. The system of claim 9, wherein the first and second light sources comprise II-VI 1-D quantum well emitters.

12. The system of claim 9, wherein the first and second light sources comprises LEDs.

13. The system of claim 10, further comprising a spectral filter to narrow the spectral emission band of one or more of the quantum well emitters.

14. The system of claim 11, further comprising a spectral filter to narrow the spectral emission band of one or more of the II-VI 1-D quantum well emitters.

15. The system of claim 12, further comprising a spectral filter to narrow the spectral emission band of one or more of the LEDs.

16. The system of claim 9, further comprising a glare reduction filter on a viewer side of the glasses.

17. The system of claim 9, wherein the first set of light sources comprise red-green-blue light sources on a single die.

18. The system of claim 9, wherein the first and second sets of light sources comprise red-green-blue-yellow light sources on a single die.

19. A 2D display system, comprising:
an LCD panel; and
a backlight for providing light to the LCD panel, comprising
a light guide located behind the LCD panel; and
light sources located on at least one edge of the light guide to transmit light into the light guide, wherein the light sources comprise narrow band light sources.

20. The system of claim 19, wherein the light sources comprise II-VI 1-D quantum well emitters.

21. The system of claim 19, wherein the light sources comprise red-green-blue light sources on a single die.

22. The system of claim 19, wherein the light sources comprise red-green-blue-yellow light sources on a single die.

23. A pair of lenses for 3D glasses for use with a four-color 3D display system, comprising:
a first lens, comprising:
a stack of oriented PET and coPMMA materials having a first blocking band substantially blocking green light and a second blocking band substantially blocking red light; and
a layer of dye applied to the stack, the dye substantially blocking blue light,
wherein the first lens transmits yellow light; and
a second lens, comprising:
a filter substantially blocking yellow light,
wherein the second lens transmits red, green, and blue light.

24. The lenses of claim 23, wherein the first lens is a left eye lens and the second lens is a right eye lens.

25. The lenses of claim 23, wherein the first lens is a right eye lens and the second lens is a left eye lens.
